(19) United States
(12) Patent Application Publication
(10) Pub. No.: US 2014/0108268 A1
(43) Pub. Date: Apr. 17, 2014

(54) SYSTEM AND METHOD FOR COLLABORATIVELY MANAGING FINANCIAL TASKS

(71) Applicants: Devin Miller, North Bend, WA (US); Andrew Buhrmann, Bellevue, WA (US); David Haner, Mountlake Terrace, WA (US); Craig Carns, Olympia, WA (US); Trevor Honsberger, Newcastle, WA (US)

(72) Inventors: Devin Miller, North Bend, WA (US); Andrew Buhrmann, Bellevue, WA (US); David Haner, Mountlake Terrace, WA (US); Craig Carns, Olympia, WA (US); Trevor Honsberger, Newcastle, WA (US)

(21) Appl. No.: 13/960,606

(22) Filed: Aug. 6, 2013

Related U.S. Application Data
(60) Provisional application No. 61/679,986, filed on Aug. 6, 2012.

(51) Int. Cl. G06Q 10/10

(52) U.S. Cl. CPC G06Q 10/103
USPC 705/301

(57) ABSTRACT

A method of collaborating with a plurality of parties in an online system.

### PRIORITY CLAIM

This application claims the benefit of and incorporates by reference in its entirety U.S. Provisional Patent Application No. 61/679,986 filed on Aug. 6, 2012.

### BACKGROUND OF THE INVENTION

Personal & business finance is an ongoing chore that requires constant management and oversight. It is a complex chore that is typically managed and accomplished by a diverse set of parties including the individual, spouses, business partners, business colleagues, trusted friends & family as well as a variety of trusted financial professionals with diverse skill sets. To accomplish tasks such as paying bills, tracking expenses, making financial decisions, investing, preparing annual tax filings, managing business finances and other such chores, a diverse set of potentially private and sensitive information must be shared and discussed across this diverse set of events and potential participants. Further, to accomplish these tasks, an individual user must not only be able to organize tasks and projects around financial chores but also maintain original reference material and documentation related to the task.

### BRIEF DESCRIPTION OF THE DRAWINGS

Preferred and alternative examples of the present invention are described in detail below with reference to the following drawings:

FIG. 1 is a screen shot which shows a collaborative session within a personal finance system, including an object that can be made into a note, message or task, 1; a link to the dynamic data referenced in the object, 2; the Static reference, 3 and 4; the object detail such as name and detail as defined by the user, 5; the users who are able to view or interact with the object and attached reference, 6; a social feature allowing users to comment on the object, 7; and the ability to define the object as a Task, assign a due date and task owner as well as assign the Task to a broader Project, 8.

FIG. 2 is a screen shot which shows an example of a Note, Message or Task within a personal finance software program or online/mobile banking website containing a Dynamic Reference, 9; the Dynamic Reference being displayed as a Static Reference, 10; and a link to the Dynamic Reference attached to the Note, Message or Task as well as the Static reference, 11.

FIG. 3 shows what the Dynamic reference looks like when opened by a user. The Dynamic Reference is automatically updated from its source (3^{rd} party data provider or internal financial institution data) and the information retained within the Dynamic Reference is actionable in that any action by the user to change the data is then updated within the personal finance software, online bank, financial institution internal systems or 3^{rd} party sources.

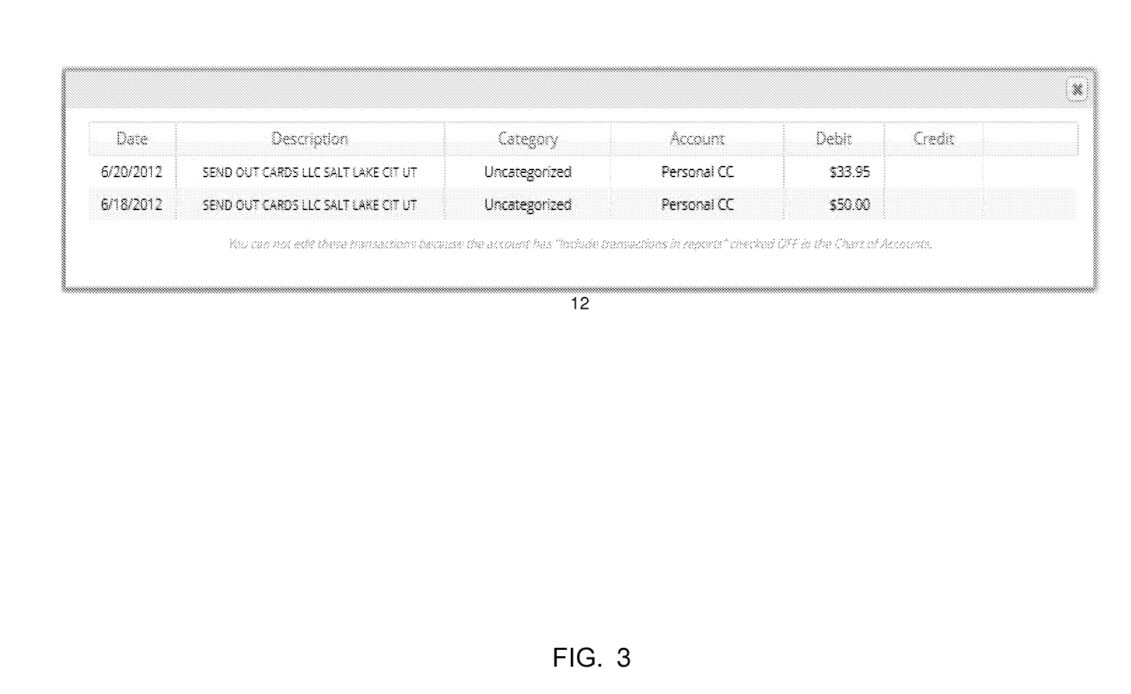

FIG. 4 shows An example of accessing financial information relevant to a collaborative session for sharing and managing financial chores. The example shows the ability to define the type of contact and the permissions granted.

FIG. 5 shows an example of accessing financial information relevant to a collaborative session, including a personal financial software program, a financial institution or the internal data available (CRM, client historical data, etc) at a financial institution, 13; a collaborative session that allows for interaction between a varied group of users interacting around a task, note, project or other joint effort related to the financial information, 14 referenced in any type of financial information which could be displayed as a Static or Dynamic reference, 15; a user within the collaborative session requesting a change to the reference information or otherwise requesting action to be taken to alter some piece of information relevant to the source or a 3^{rd} party, 16; and the Collaborative system directing the request for action to the appropriate 3^{rd} party and/or original source, 17.

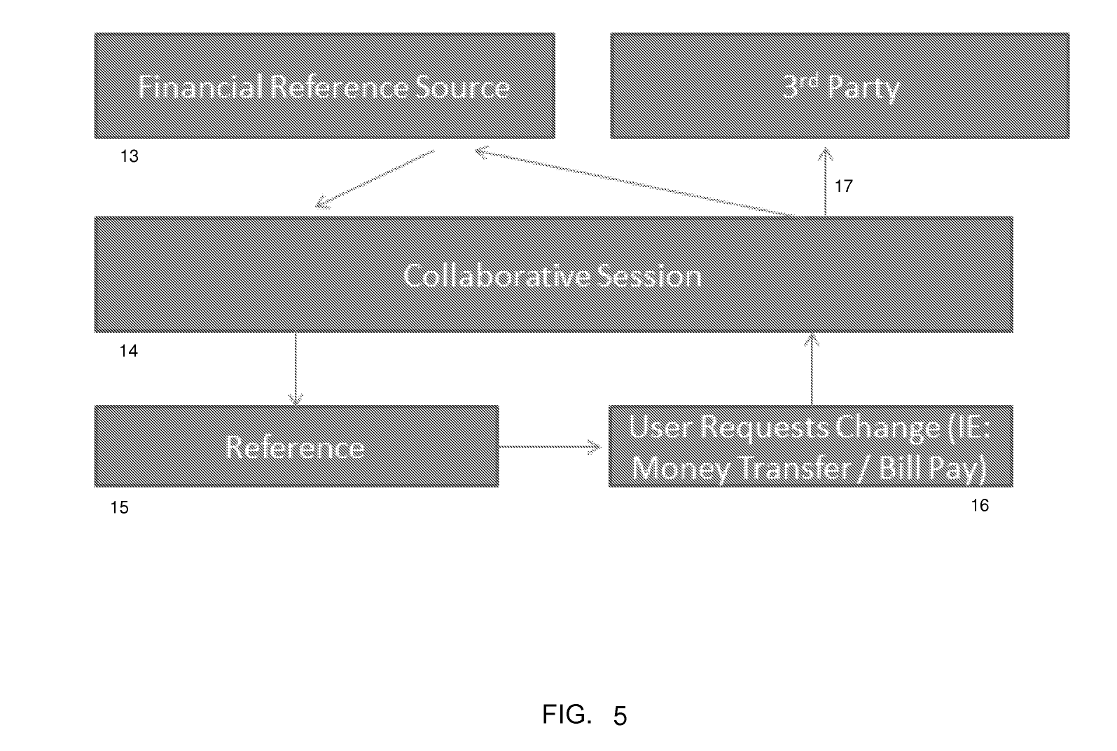

### DETAILED DESCRIPTION OF THE PREFERRED EMBODIMENT

An embodiment provides the ability to collaborate with a multitude of parties such as family or trusted professionals within a PFM or online banking system where multiple users can be involved with varying permissions all while viewing the same note, task, project, reference or other object. The ability to create projects or tasks (and creating a template for them) that reference financial information across multiple users with diverse roles and permissions within a PFM or online banking system. The ability to view Dynamic or Static Reference material substantive to the collaborative session where the Dynamic Reference can be manipulated and the change recorded at the source.

Embodiments provide a system and method for collaboratively managing financial tasks between a diverse set of participants is provided. A user is able to create a collaborative session with multiple users within a PFM or online banking system where multiple users can be involved with varying permissions all while viewing the same reference material. Further, the user is able to create, assign and otherwise manage projects and tasks across a multitude of users with diverse roles and permissions within a PFM or online banking system all while maintaining original reference material to enrich the context of the collaborative session. The solution is specifically designed for a finance software program or online banking platform for consumers, business owners and/or financial service professionals. The professionals may be any type of service provider including private bankers, financial planners, tax preparers, CPAs, bookkeepers, commercial bankers, customer support professionals or any other person or entity engaged in assisting consumers or businesses with managing and completing financial tasks.

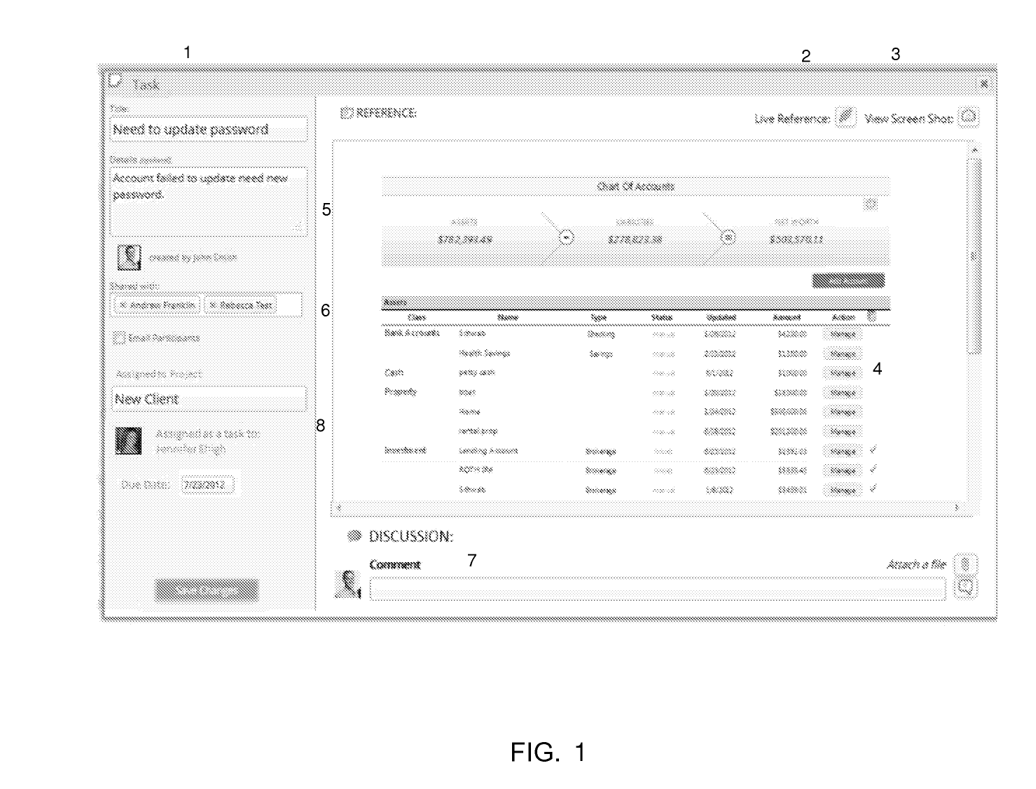

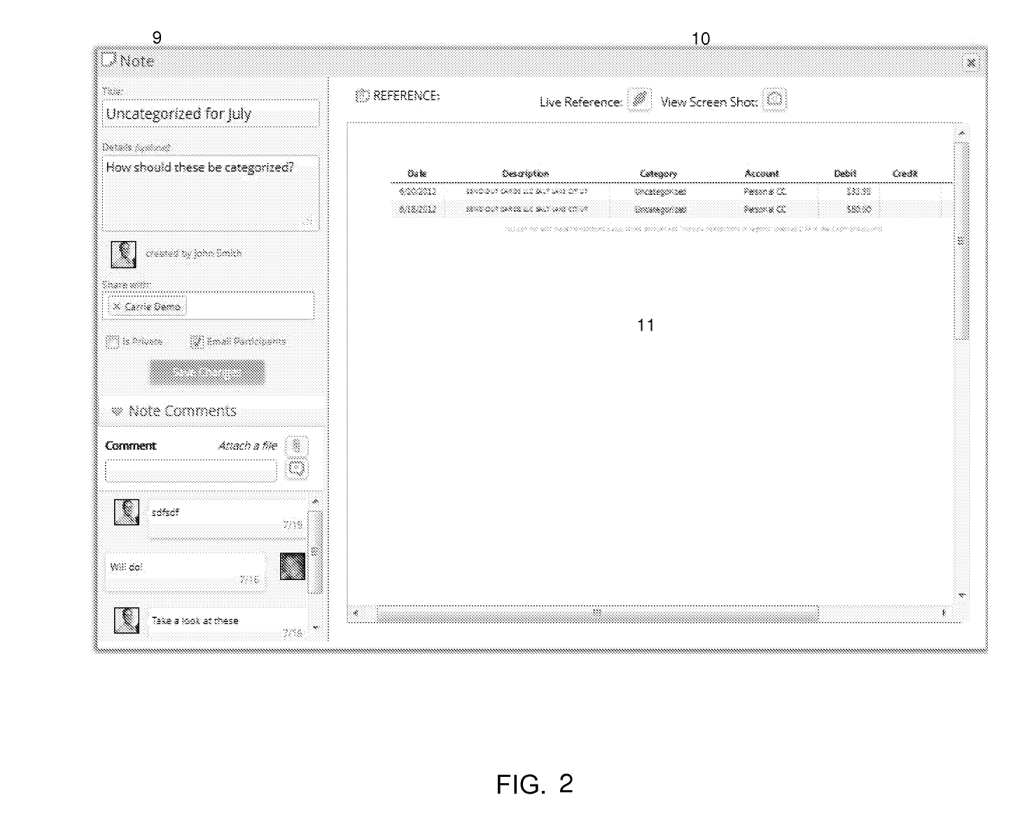

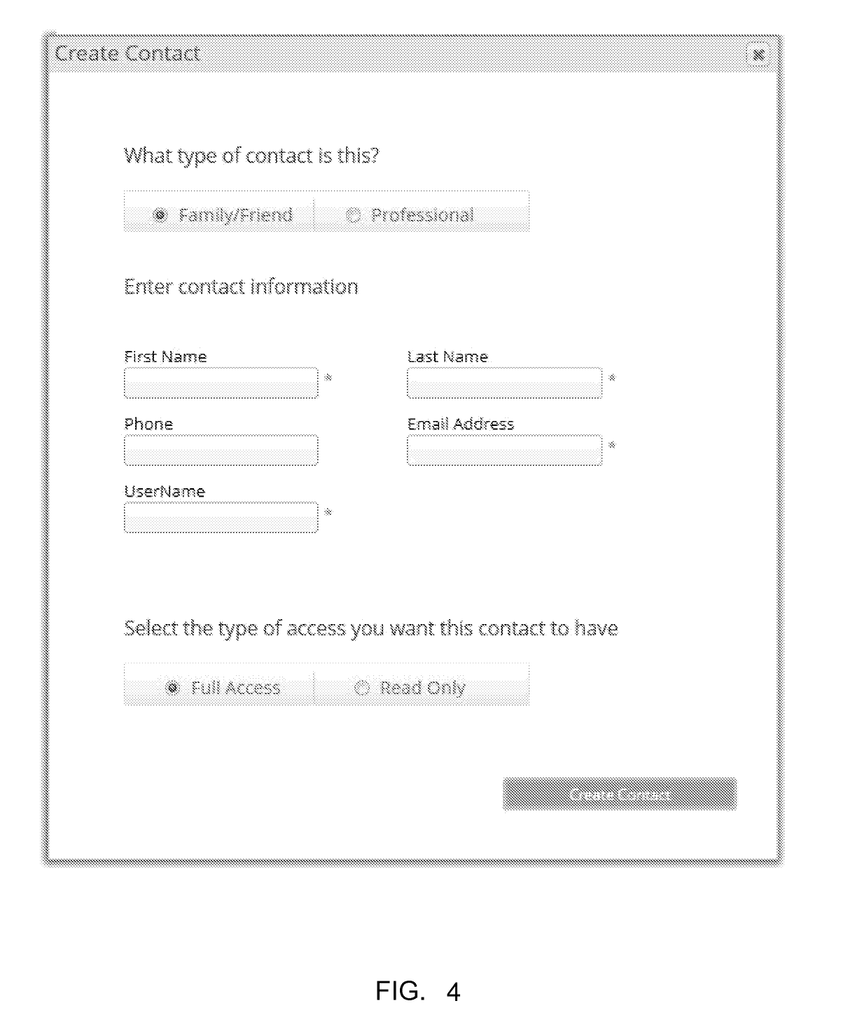

The components of at least one embodiment include:
An automated software process with the ability to invite multiple users to share information related to an account, online portal, online bank account or other financial information where an individual or entity has ownership of the financial information. The contact is stored in a computer software system. (FIG. 4).
Ability to manage permissions, access and information access to a variety of users (FIG. 4).
Ability to assign roles and relationship status to the users with whom you are sharing financial information. Also, the ability to preset access and permissions based on roles or groups (FIG. 4).
Ability to create a conversation, group, discussion, screen sharing, project or other collaborate session with the users related to the shared information that takes into account permissions and access levels (FIG. 1.)
Ability to reference, clip, tag or otherwise include a specific piece of financial information to a specific conversation or collaborative event. Where the reference can be an image, PDF, excel file or other permanent data point or object. Where the reference may also be a dynamic set of data such as an account balance, list of transactions, report or calculation all of which may be changing or updating automatically over time. The reference may include a link to the dynamic data to be accessed later (2-4 of FIG. 1.)
Ability to create tasks & projects for the multitude of users leveraging the referenced material and documentation (8 of FIG. 1.)
Ability to create templates of projects or tasks that can be used as a starting point for creating a project where the template contains preset references (Static or Dynamic) as well as preset requirements for participants, documents, references and tasks.
Where the reference material can be Static, such as a document, image or other unchanging object, OR Dynamic. (FIG. 2). Dynamic reference material can be connected to 3^{rd} party sources such as banking websites or financial data sources that are automatically updated.
Further, Dynamic data sources can be actionable such as the ability to view AND pay a bill from the reference or view an automatically updating account balance AND transfer funds to the account from within the reference. Further, a Dynamic reference may include financial information specifically from a financial institution's internal data sources such as internal CRM tools, database information, customer data and other sources.
Ability for colleagues to collaborate together within a financial institution related to specific client where the client information or financial data is a Dynamic reference.
Where a Static or Dynamic reference can be attached to an existing conversation or collaborative session between parties related to individual users finances.
Where a financial institution uses the proposed system and method for managing multiple user access, permissions and information sharing & referencing which can be bolted on to a personal banking platform to increase engagement and allow for secure sharing and discussions.
Ability to take action on a Dynamic Reference where the incoming data is able to then be adjusted by the user and the adjustment is recorded within the personal finance software, online bank, financial institution internal systems or 3^{rd} party sources.

### Use Case:

A consumer is using a personal finance software program or online banking platform to track an investment portfolio. The consumer is married and has granted partial access to a spouse who can also view investment activities, account balances and reports in a limited manner. Further, the consumer has added a financial planner and private banker as contact on his account. While using the software program, the consumer has a question related to an investment account and a specific transaction. The consumer is able to create a note, message, task or other form of collaborative object and tag, reference or otherwise include the specific financial information his question is related to. From there, the consumer shares the information and his related question with any of the users on his account. They in turn can view the question or reference and make further comments or assign tasks or create additional collaborative objects from there.

### Benefit:

This allows for a more secure sharing of information and ability to control access to financial information. Further, this process of sharing and collaborating allows for simpler, more private sharing of financial information. It further allows for more effective financial advice and service delivery as all discussions are managed through a private area that contains a constant connection to the reference material, conversation and participants.

While the preferred embodiment of the invention has been illustrated and described, as noted above, many changes can be made without departing from the spirit and scope of the invention. For example, one embodiment of the invention may be operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Another embodiment of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Yet another embodiment of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort. Accordingly, the scope of the invention is not limited by the disclosure of the preferred embodiment. Instead, the invention should be determined entirely by reference to the claims that follow.

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms

The embodiments of the invention in which an exclusive property or privilege is claimed are defined as follows:

What is claimed is:

1. A method of collaborating with a plurality of parties in an online system.
